(19) United States
(12) Patent Application Publication
(10) Pub. No.: US 2006/0029227 A1
(43) Pub. Date: Feb. 9, 2006

(54) Storage

(75) Inventors: Renatus Josephus Van Der Vleuten, Eindhoven (NL); Gerardus Wilhelmus Theodorus Van De Heijden, Eindhoven (NL); Wilhelmus Hendrikus Alfonsus Bruls, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/531,608

(22) PCT Filed: Sep. 22, 2003
(86) PCT No.: PCT/IB03/04213

§ 371 Date: Apr. 14, 2005

(30) Foreign Application Priority Data
Oct. 18, 2002 (EP) 02079339.4

(51) Int. Cl. H04N 7/167

(52) U.S. Cl. 380/200

(57) ABSTRACT

A method and apparatus for delivering content to a user are disclosed. A data bit-stream is provided having a base layer data bit-stream and at least one enhancement layer data bit-stream. The data bit-streams are stored separately in a storage device. The stored content is then offered at different quality levels. When a request is received from the user for the content at a specified quality level, the base layer data bit-stream and however many enhancement layer data bit-streams that are needed to produce the specified quality level are downloaded to the user.

### FIELD OF THE INVENTION

The invention relates to the storage of video content, and more particularly to a method for selling the same stored video content at different quality levels.

### BACKGROUND OF THE INVENTION

Many video applications are enabled where video is available at various resolutions and/or qualities in one bit-stream. Methods to accomplish this are loosely referred to as scalability techniques. There are three axes on which one can deploy scalability. The first is scalability on the time axis, often referred to as temporal scalability. Secondly, there is scalability on the quality axis (quantization), often referred to as signal-to-noise (SNR) scalability or fine-grain scalability. The third axis is the resolution axis (number of pixels in image) often referred to as spatial scalability. In layered coding, the bit-stream is divided into two or more bit-streams, or layers. Each layer can be combined to form a single high quality signal. For example, the base layer may provide a lower quality video signal, while the enhancement layer provides additional information that can enhance the base layer image. With spatial scalability, the base layer video may have a lower resolution than the input video sequence, in which case the enhancement layer carries information which can restore the resolution of the base layer to the input sequence level.

Typically, these scaled video bit-streams are stored together in a storage device by the content provider or service provider, so the quality level of the stored video content is fixed by the processing which was performed prior to storing the content. A user can access the storage device or the storage device can download the scaled video bit-streams for display at a user device.

### SUMMARY OF THE INVENTION

If a service or content provider wants to offer the video content for sale at different quality levels, the same video content will need to be processed and stored for each quality level offered for sale. This can be very problematic from a storage stand point since video data consumes large quantities of storage space. Thus, there is a need for a method and apparatus for providing a way to offer for sale the same stored video content at different quality levels without having to store the content multiple times. The invention overcomes the deficiencies described above by storing the different layers of video bit-streams separately in an elastic storage device, wherein the elastic storage device sends the appropriate video bit-streams to the user to create a final video bit-stream with a selected quality level.

According to one embodiment of the invention, a method and apparatus for delivering content to a user are disclosed. A data bit-stream is provided having a base layer data bit-stream and at least one enhancement layer data bit-stream. The data bit-streams are stored separately in a storage device. The stored content is then offered at different quality levels. When a request is received from the user for the content at a specified quality level, the base layer data bit-stream and however many enhancement layer data bit-streams that are needed to produce the specified quality level are downloaded to the user.

According to another embodiment of the invention, a method and receiver for receiving multilayered content which can be displayed at different quality levels are disclosed. Layered content is received comprising a base layer bit-stream and at least one enhancement bit-stream. A selected quality level of display is received for the layered content. A determination as to which enhancement-bit-streams need to be combined with the base layer bit-stream to create the selected quality level is then made. The combination of selected streams are then displayed.

These and other aspects of the invention will be apparent from and elucidated with reference to the embodiments described hereafter.

### BRIEF DESCRIPTION OF THE DRAWINGS

The invention will now be described, by way of example, with reference to the accompanying drawings, wherein:

FIG. 1 is a block diagram of a video content distribution system according to one embodiment of the invention;

FIG. 2 is a block diagram of an elastic storage device according to one embodiment of the invention;

FIG. 3 is a block diagram of a layered video encoder according to one embodiment of the invention.

### DETAILED DESCRIPTION OF THE INVENTION

According to one embodiment of the invention, scalable video content is stored in an elastic memory device. While the following illustrative examples will discuss stored video data, it will be understood by those skilled in the art that the invention also applies to other stored data, e.g., audio data, audio/video data, but the invention is not limited thereto. For storing data items such as digital video, audio and images on a storage medium with a fixed capacity, elastic storage is a very efficient way of utilizing the storage capacity of the medium. The principles of elastic storage are described in the published European Patent Application No. WO0169939 of the applicant, entitled “Compressed Storage Of Data Items”. According to the elastic storage principle, a digital data item to be stored is first divided into successive data pieces of decreasing significance. Consequently, the data pieces are stored in a memory provided there is enough space to accommodate all the pieces. In case the memory does not have enough space, space is created by removing from the memory those data pieces from various items that have the lowest significance. The thus freed space is used for storing the data pieces of the data item to be stored. Preferably, an auxiliary memory is used for recording the identification data, such as file name and significance, of all the data pieces stored in the memory.

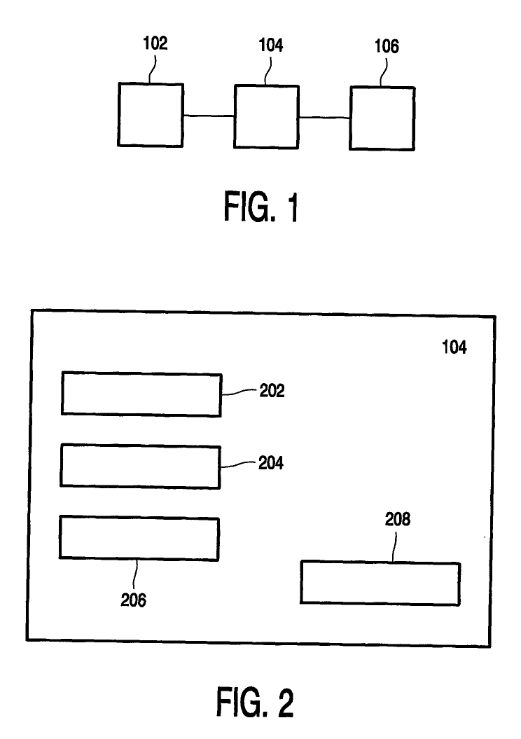

As illustrated in FIG. 1, a service provider or content provider encodes the video content in an encoder 102 using a known scalable compression method. The encoded video content is then sent to the storage device 104, for example, a set-top box. In this embodiment, the encoder 102 can be a transmitter and the storage device 104 can be a receiver, wherein the signals form the encoder 102 to the storage device can be transmitted through various medium such as, for example, air, cable, fiber optic cables, etc. The storage device 104 stores each layer of the encoded video bit-stream, for example, a base layer 202, a first enhancement layer 204 and a second enhancement layer 206, separately as illustrated in FIG. 2. In this embodiment, the base layer video bit-stream and the two enhancement layer video bit-streams are stored separately in the storage device 104. When a user device 106 requests the video content to be delivered with a specified quality level, a storage controller 208 selects the different layers of video bit-streams which are needed to reproduce the video content with the specified quality level. It will be understood by those skilled in the art that the storage device 104 and the user device 106 can be incorporated into a single device such as, for example, a television, computer, etc. As mentioned above, the invention is not limited to video data but also extends to other stored data such as audio data. For example, the base layer could be used for mono or stereo sound while the enhancement layer can be used to extend the sound to, for example, full 5.1 surround sound.

The business model of selling the same content at different quality levels is closely related to elastic storage, since there too the same content is stored at multiple quality levels using scalable compression. The quality levels that are offered for purchase to the consumer can correspond to the quality levels used in the elastic storage system. This implies that when the elastic storage device wants to lower the quality of a certain content item, the device can remove the highest encrypted layer, without needing to decrypt the layer. Since the device does not decrypt any data, there is no security or theft risk. To maintain security in the whole chain from the content owner or service provider to the consumer, the content is preferably compressed, e.g., using a scalable compression method, and encrypted at the desired quality levels by the content owner and then distributed in encrypted form to the elastic storage device either directly transmitted or downloaded or indirectly via e.g., intermediate storage on an optical disk.

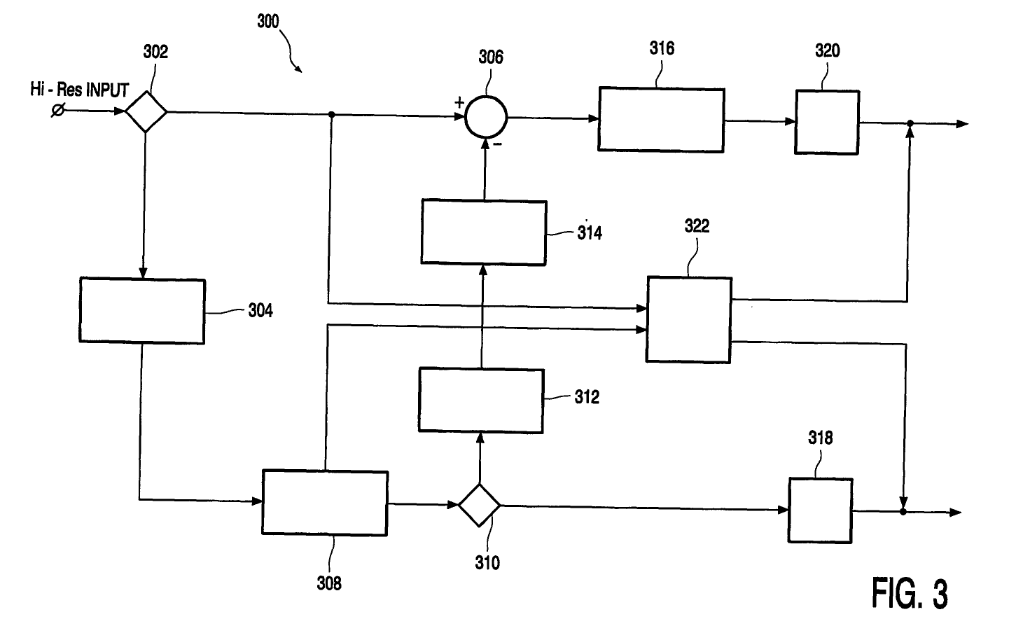

FIG. 3 illustrates a known spatial scalable video encoder 300. While this illustrative example just has a base layer and one enhancement layer, it will be understood by those skilled in the art that the encoder can have any number of enhancement layers and the invention is not limited thereto. The depicted encoding system 300 accomplishes layer compression, whereby a portion of the channel is used for providing a low resolution base layer and the remaining portion is used for transmitting edge enhancement information, whereby the two bit-streams may be recombined to bring the system up to high-resolution. The high resolution video input is split by splitter 302 whereby the data is sent to a low pass filter 304 and a subtraction circuit 306. The low pass filter 304 reduces the resolution of the video data, which is then fed to a base encoder 308. In general, low pass filters and encoders are well known in the art and are not described in detail herein for purposes of simplicity. The encoder 308 produces a lower resolution base bit-stream which can be broadcast, received and via a decoder, displayed as is, although the base bit-stream does not provide a resolution which would be considered as high-definition.

Via a splitter 310, the output of the encoder 308 is also fed to a decoder 312 within the system 300. From there, the decoded signal is fed into an interpolate and upsample circuit 314. In general, the interpolate and upsample circuit 314 reconstructs the filtered out resolution from the decoded video bit-stream and provides a video data bit-stream having the same resolution as the high-resolution input. However, because of the filtering and the losses resulting from the encoding and decoding, loss of information is present in the reconstructed bit-stream. The loss is determined in the subtraction circuit 306 by subtracting the reconstructed high-resolution bit-stream from the original, unmodified high-resolution bit-stream. The output of the subtraction circuit 306 is fed to an enhancement encoder 316 which outputs a reasonable quality enhancement bit-stream. Optionally, the encoder 300 may also include encryption devices 318 and 320 to encrypt the base layer video bit-stream and the enhancement layer video bit-stream, respectively. Preferably, each encoded video bit-stream is encrypted with a different encryption. It will be understood by those skilled in the art that a single encryption device could also be used to encrypt each encoded video bit-stream.

In an elastic storage application using this embodiment of the invention, the user (or the device based on what it knows about the preferences of the user) may optionally select a certain desired minimum quality level, i.e., content that is currently available at a higher quality level than minimally desired by the user may be reduces in quality to make room for more different content, until it reaches the lowest quality level acceptable to the user. When the content is still available in a higher quality, however, the user still has the option to purchase the higher quality. Of course, the user (or device) may also preset different desired minimum quality levels for different types of content (like sports, talk shows, or movies).

Alternately, it is also possible to let the service provider manage the storage space and determine which quality levels should be removed (in that case, the service provider keeps track of the qualities and may carry out the elastic storage functions). This could be useful, e.g., when the content is put on a set-top box containing a storage function, e.g., hard disk, by the service provider. Initially, the content could be offered to the user at a high quality. When the user does not watch/buy the content within a predetermined period of time, the quality level stored on the set-top box can be lowered to make room for different content.

According to another embodiment of the invention, quality information about each layered encoded video bit-stream can be included as side information which is stored with each video bit-stream in the elastic storage device 104. Quality information and the generation of quality information is described in published European Patent Application No. WO0232147. Briefly, the quality information is generated by the encoder 300 in a quality information generator 322. The quality information generator 322 extracts object quality from the input video signal as well as the signals and/or parameters provided by the encoder 300. The quality information can indicate a quality of the object in relation to the given position in (or a given part of) the bit-stream. By adding quality information to the bit-stream, jointly storing or transmitting multiple coded objects can be optimized in that the quality of the object can be easily taken into account. The quality information from the quality information generator 322 is provided to the encoder 300, which generates the quality information tags and inserts them into the bit-stream. The quality information is not part of each video bit-stream or alternatively can be added to the video bit-stream after the encryption process so the quality information is not encrypted as illustrated in FIG. 3. In this embodiment, the storage controller 208 can read the quality information and then select which layered video bit-streams are needed to create the video content at the quality level selected by the user.

It will be understood that the different embodiments of the invention are not limited to the exact order of the above-described steps as the timing of some steps can be interchanged without affecting the overall operation of the invention. Furthermore, the term “comprising” does not exclude other elements or steps, the terms “a” and “an” do not exclude a plurality and a single processor or other unit may fulfill the functions of several of the units or circuits recited in the claims.

1. A method for delivering content to a user, comprising the steps of:
providing a data bit-stream having a base layer data bit-stream and at least one enhancement layer data bit-stream;
storing the base layer data bit-stream and the at least one enhancement layer data bit-stream separately in a storage device;
offering the stored content at different quality levels;
receiving a request from the user for the content at a specified quality level;
downloading to the user the base layer data bit-stream and however many enhancement layer data bit-streams are needed to produce the specified quality level.

2. The method according to claim 1, wherein the data bit-stream is a video bit-stream.

3. The method according to claim 2, further comprising the steps of:
encrypting the base layer video bit-stream using a first encryption;
encrypting each enhancement layer video bit-stream using different encryption.

4. The method according to claim 2, further comprising the step of:
adding quality information to each video bit-stream specifying the quality level of the individual video bit-stream, wherein the storage device reads the quality information so as to download the video content with the quality level specified by the user.

5. The method according to claim 2, further comprising the step of:
lowering the available quality level in the storage device by deleting at least one enhancement layer for the video content when the user does not select the video content within a predetermined period of time.

6. The method according to claim 2, wherein the storage device determines the specified quality level based on the number of different quality layers available for the selected video content.

7. The method according to claim 1, wherein the base layer data bit-stream and the at least one enhancement layer data bit-stream are encoded prior to being stored.

8. An apparatus for delivering content to a user, comprising:
means for providing a data bit-stream having a base layer data bit-stream and at least one enhancement layer data bit-stream;
storage device for storing the base layer data bit-stream and the at least one enhancement layer data bit-stream separately;
means for offering the stored content at different quality levels;
means for receiving a request from the user for the content at a specified quality level;
means for downloading to the user the base layer data bit-stream and however many enhancement layer data bit-streams are needed to produce the specified quality level.

9. The apparatus according to claim 8, wherein the data bit-stream is a video bit-stream.

10. The apparatus according to claim 9, further comprising:
first encryption means for encrypting the base layer video bit-stream;
encryption means for encrypting each enhancement layer video bit-stream using different encryption.

11. The apparatus according to claim 9, further comprising:
a quality information generator for adding quality information to each video bit-stream specifying the quality level of the individual video bit-stream, wherein the storage device reads the quality information so as to download the video content with the quality level specified by the user.

12. The apparatus according to claim 9, further comprising:
means for lowering the available quality level in the storage device by deleting at least one enhancement layer for the video content when the user does not select the video content within a predetermined period of time.

13. The apparatus according to claim 9, wherein the storage device determines the specified quality level based on the number of different quality layers available for the selected video content.

14. The apparatus according to claim 8, wherein the base layer data bit-stream and the at least one enhancement layer data bit-stream are encoded prior to being stored.

15. A method for receiving multilayered content which can be displayed at different quality levels, comprising the steps of:
receiving layered content comprising a base layer bit-stream and at least one enhancement bit-stream;
receiving a selected quality level of display for said layered content;
determining which enhancement bit-streams need to be combined with the base layer bit-stream to create the selected quality level;
displaying combination of selected streams on a display.

16. A receiver for receiving multilayered content which can be displayed at different quality levels, comprising:
means for receiving layered content comprising a base layer bit-stream and at least one enhancement bit-stream;
means for receiving a selected quality level of display for said layered content;
means for determining which enhancement bit-streams need to be combined with the base layer bit-stream to create the selected quality level;
means for displaying combination of selected streams on a display.

17. A storage medium for storing multilayered content which can be displayed at different quality levels, comprising:
means for receiving layered content comprising a base layer bit-stream and at least one enhancement bit-stream;
means for storing the base layer bit-stream and the at least one enhancement layer bit-stream separately
means for receiving a selected quality level of display for said layered content;
means for determining which enhancement bit-streams need to be combined with the base layer bit-stream to create the selected quality level
means for downloading a combination of selected streams for display.
